(19) United States
(12) Patent Application Publication
(10) Pub. No.: US 2014/0353979 A1
(43) Pub. Date: Dec. 4, 2014

(54) METHOD FOR OPERATING A CONVERTER FOR A STARTER MOTOR

(71) Applicants: Fabio Magini, Hemmingen (DE); Paul Mehringer, Stuttgart (DE); Markus Baur, Rottenburg (DE)

(72) Inventors: Fabio Magini, Hemmingen (DE); Paul Mehringer, Stuttgart (DE); Markus Baur, Rottenburg (DE)

(21) Appl. No.: 14/351,022

(22) PCT Filed: Sep. 19, 2012
(86) PCT No.: PCT/EP2012/068421

§ 371 Date: Apr. 10, 2014

(30) Foreign Application Priority Data
Oct. 10, 2011 (DE) 10 2011 084 230.6

(51) Int. Cl. F02N 11/08

(52) U.S. Cl. CPC F02N 11/08
USPC 290/38 C

(57) ABSTRACT

A method is described for operating a converter for a starter motor, in particular a belt-driven starter motor, of a vehicle, including the steps of detecting a temperature of the converter, and controlling a current supplied to the converter as a function of the detected temperature using a setpoint temperature as a reference variable. In addition, the invention describes a converter for a starter motor of a vehicle which is capable of carrying out the method according to the invention.

### FIELD OF THE INVENTION

The present invention relates to a method for operating a converter for a starter motor and a converter for carrying out the method.

### BACKGROUND INFORMATION

For operating an electric machine, alternating voltage may be converted into direct voltage with the aid of a converter. However, heat may form in the process which may put strain on the converter. German Published Patent Appln. No. 10 2010 001 250 discloses a vehicle electrical system having two converters including multiple switching elements for operating an electric machine. This may help reduce the thermal strain on the particular converter.

### SUMMARY

An object underlying the present invention is to provide a method for operating a converter and a converter in which the thermal strain due to fluctuating temperatures is further reduced.

According to one aspect of the present invention, the object is achieved with the aid of a method for operating a converter for a starter motor of a vehicle, including the steps of detecting a temperature of the converter, and controlling a current supplied to the converter as a function of the detected temperature using a setpoint temperature as the reference variable. Using a setpoint temperature as the reference variable is advantageous in that the converter may be kept at a setpoint temperature during operation and strains due to thermal fluctuations may be reduced to a minimum. In this way, the service life of the converter may be increased.

In one advantageous specific embodiment, the setpoint temperature is established as a function of a vehicle condition. This is advantageous in that a different setpoint temperature may be selected depending on the state of the vehicle. For example, the setpoint temperature may approach the maximum setpoint temperature in small steps after starting vehicle. This additionally reduces thermally induced mechanical strains in the converter when the vehicle is started.

In another advantageous specific embodiment, the supplied current is interrupted if the setpoint temperature is exceeded. This is advantageous in that an immediate cooling is achieved if the setpoint temperature is exceeded.

In another advantageous specific embodiment, the supplied current is reduced if the setpoint temperature is exceeded. This is advantageous in that the temperature is slowly returned to the setpoint temperature and strong thermal fluctuations of the inverter are avoided.

In another advantageous specific embodiment, the temperature of a semiconductor component of the converter is detected. This is advantageous in that the temperature is detected directly at the heat source, and peak temperatures in the area of the semiconductor elements are avoided.

In another advantageous specific embodiment, the semiconductor element is a switchable component or a rectifying component. This is advantageous in that different setpoint temperatures may be used as reference variables depending on the type of the component.

In another advantageous specific embodiment, the temperature of multiple semiconductor components of the converter is detected. This is advantageous in that multiple heat sources may be monitored at the same time, and the temperature may be equalized within the inverter upon occurrence of great temperature differences between the components. In the case of polyphase starter motors, an asymmetry of the phase currents may be accepted for the purpose of a uniform temperature load on the output stages involved.

In another advantageous specific embodiment, the current supplied to a semiconductor element is controlled as a function of the detected temperature of the particular semiconductor element. This is advantageous in that the temperature of each semiconductor element may be controlled independently of one another.

In one advantageous specific embodiment, the supplied current is controlled via a pulse width modulation. This is advantageous in that the current may be controlled using a particularly suitable circuit.

According to another aspect of the present invention, the object is achieved with the aid of an converter for a starter motor of a vehicle, with the aid of a temperature detection device for detecting a temperature of the converter, and a regulating device for controlling a current supplied to the converter as a function of the detected temperature using a setpoint temperature as the reference variable. In this way, the same advantages are achieved as by the above-described method.

### BRIEF DESCRIPTION OF THE DRAWINGS

FIG. 1 shows a wiring diagram of a converter having four switching elements and two phases according to the related art.

FIG. 2 shows a wiring diagram of a converter having six switching elements and three phases according to the related art.

FIG. 3 shows a wiring diagram of a converter having ten switching elements and five phases according to the related art.

FIG. 4 shows a schematic illustration of a first specific embodiment of the converter.

FIG. 5 shows a schematic illustration of a control loop being used for controlling a temperature in the converter.

FIG. 6 shows a schematic illustration of a second specific embodiment of the converter.

FIG. 7 shows a schematic illustration of a third specific embodiment of the converter.

FIG. 8 shows a flow chart for controlling the temperature of the converter.

### DETAILED DESCRIPTION

The present invention will be elucidated below based on the drawings of the construction and the mode of operation of the illustrated present invention.

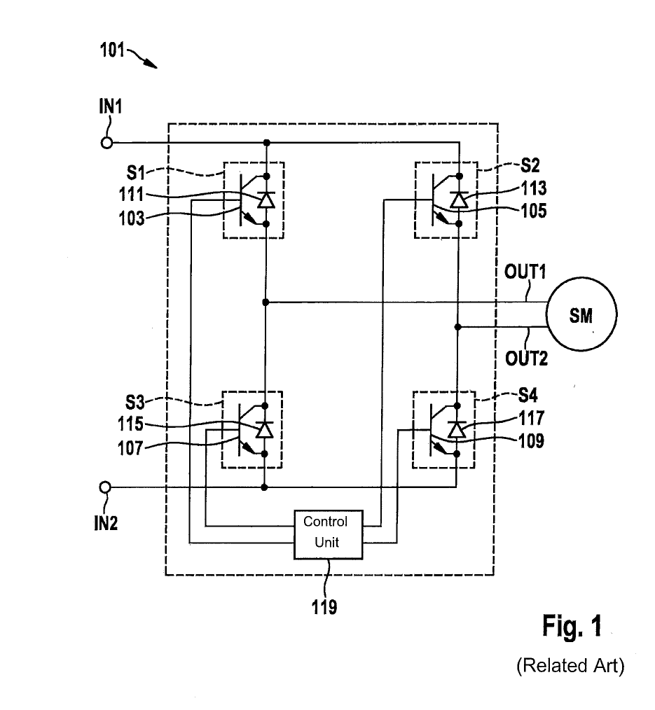

For illustration purposes of the individual components, FIG. 1 first shows an inverter 101, known from the related art, which is used as a converter for converting direct current into a two-phase alternating current for a starter motor SM. In another specific embodiment, the method according to the present invention may, however, also be used for 3-, 5-, or 6-phase systems having other converters. The direct current is supplied to inverter 101 via inputs IN1 and IN2. The inverter converts the supplied direct current into an alternating current between outputs OUT1 and OUT2 in such a way that an electric motor SM may be driven by the alternating current for starting an internal combustion engine.

Inverter 101 includes switching elements S1, S2, S3 and S4 which are used to convert the supplied direct current into an alternating current. Each of these switching elements S1, S2, S3 and S4 includes a switchable semiconductor component 103, 105, 107 and 109 and a rectifying semiconductor component 111, 113, 115 and 117. Switchable semiconductor components 103, 105, 107 and 109 are electronic components for a controlled switching of electric currents. These types of semiconductor components 1-3, 105, 107, and 109 may be transistors, e.g., field effect transistors, barrier layer field effect transistors, metal oxide semiconductor field effect transistors (MOSFET) or other types of transistors which are suitable for the purpose of switching currents. Rectifying components 111, 113, 115 and 117 are formed generally by the physically conditional inverse diode of a MOSFET. In one alternative specific embodiment, rectifying semiconductor components 111, 113, 115 and 117 may, however, also be power rectifiers, e.g., p+sn+ diodes, silicon PN diodes, or silicon Schottky diodes. Alternatively, other suitable rectifiers may, however, also be used.

In particular, the phase number of the motor is not limited to two, but may be expanded to 3-, 5-, 6- or n-phase motors, in particular when starter generators are used. In particular, advantages may be achieved in the case of polyphase systems due to a more uniform torque and due to less speed limiting control.

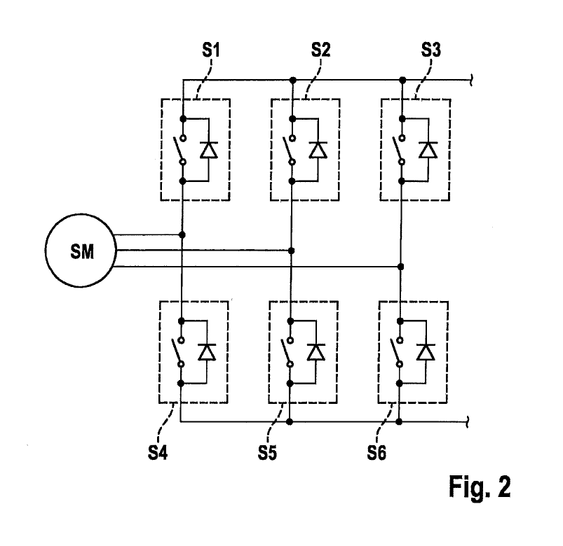

FIG. 2 shows a converter which has six switching elements S1 through S6 and three phases and on which the present invention may be used.

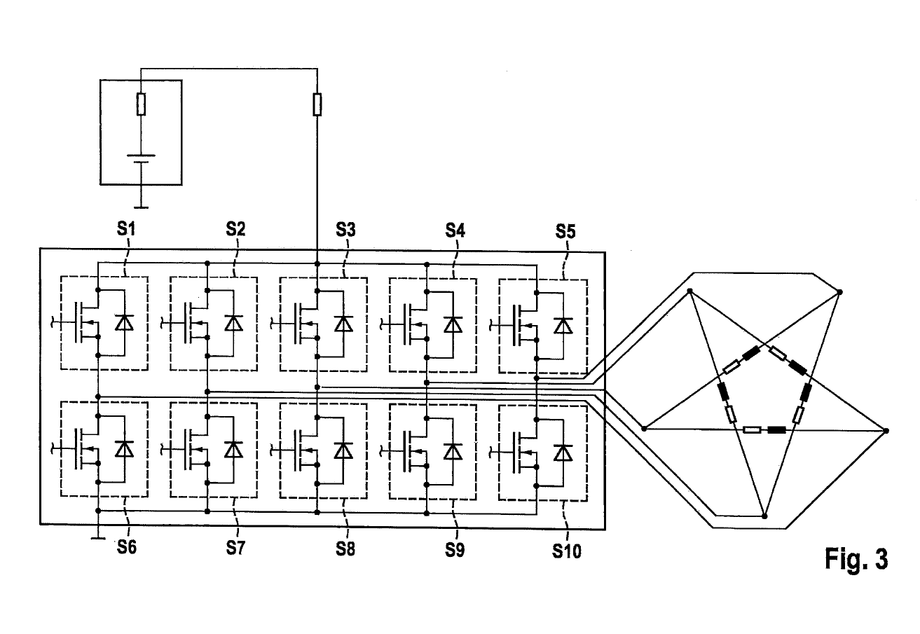

FIG. 3 shows a converter which has ten switching elements S1 through S 10 and five phases and on which the present invention may be used.

Each of switching elements S1, S2, S3 and S4 is connected to a control unit 119 via a control line. Control unit 119 controls switching elements S1, S2, S3 and S4 in such a way that the direct voltage applied to inputs IN1 and IN2 may be converted into an alternating voltage which is suitable for starter motor SM and has the appropriate frequency and amplitude. In this case, different controls of the switching elements may be used, for example, a sinus-commutated or a block-commutated pulse width modulation control. The control unit may be a programmable logic controller (PLC), for example.

The present invention is, however, not limited to the utilization of specific inverter 101 described above, but may be implemented in combination with all types of converters which are used for generating an output voltage suitable for a starter motor, such as pulse-controlled converters. Here, it is possible, in particular, that a different number of switching elements, other semiconductor components, a different control unit, and additional electronic components are used which are not necessarily semiconductor components. A converter in the sense of the present invention is therefore understood to mean every device which is suitable for generating from an input current of a certain quality an output current of a different quality suitable for a starter motor.

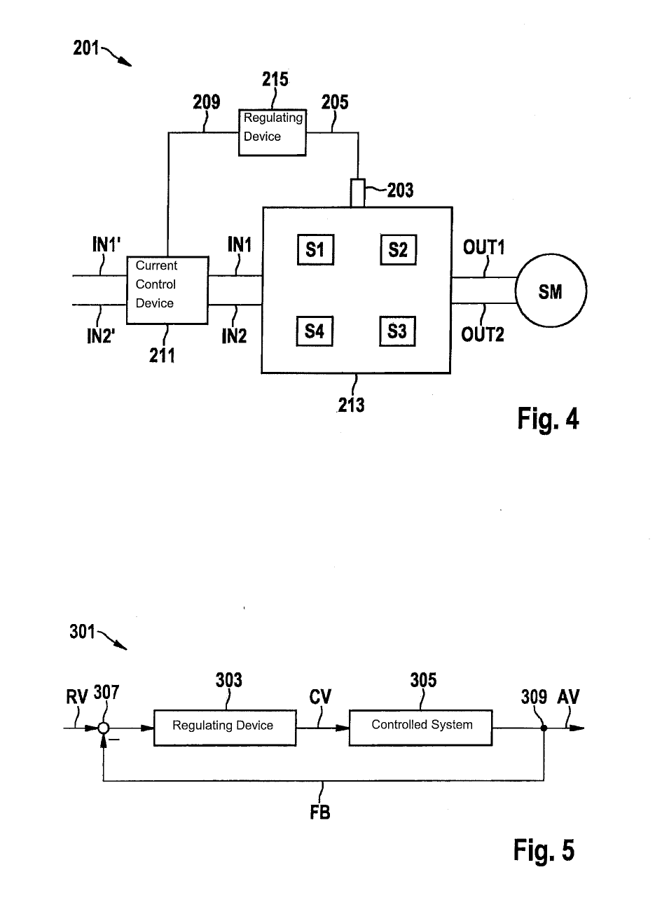

FIG. 4 shows a first specific embodiment of a converter 201 according to the present invention. Converter 201 has an converter circuit 213 including the two inputs IN1 and IN2, the two outputs OUT1 and OUT2, and the four switching elements S1, S2, S3 and S4 which are connected to starter motor SM. Switching elements S1, S2, S3 and S4 generate heat, which diffuses in the course of the operation across the entire converter 201, during operation of converter 201.

The generated heat is detected by a temperature detection device 203 at a suitable point of converter 201. This point may be on a housing or on a printed circuit board of converter 201, for example. In particular, the temperature may be detected on a switching semiconductor component, a rectifying component, or any other active or passive component, e.g., a resistor.

Temperature detection device 203 is used as a heat sensor and may, for example, be formed by an electrical NTC thermistor made of ceramic or silicon, a PTC thermistor, e.g., a resistance thermometer made of platinum, a silicon sensor, a ceramic PTC thermistor, or a semiconductor temperature sensor. Generally, all those devices may be used as temperature detection device 203 with the aid of which the temperature of converter 201 may be determined, e.g., indirect temperature detection devices suitable for determining a temperature with the aid of a measured current and/or a measured voltage.

The detected temperature value is conveyed to a regulating device 215 via a signal line 205. Regulating device 215 may include a volatile or nonvolatile memory, for example, a processor or a programmable logic which is capable of regulation on the basis of the conveyed measured temperature value. Regulating device 215 is part of a control loop and compares the temperature detected by temperature detection device 203 to a temperature setpoint value which is used as the reference variable of the control loop.

The temperature setpoint value may be fixedly predefined in a nonvolatile memory in regulating device 215 or it may be set externally by an input device (not shown). In particular, the temperature setpoint value may be changeable over time or it may be a function of a certain vehicle condition. Such a vehicle condition may be, for example, the duration of the vehicle operation or the duration of a starter motor operation.

In particular, it is advantageous when the temperature setpoint value is raised from an initially low value to a higher value in the course of the vehicle operation. For example, a second higher temperature setpoint value may be selected upon reaching a first temperature setpoint value, so that the temperature of the converter may be raised slowly and successively in selected temperature steps. By slowly raising the temperature setpoint value, strong and abrupt temperature changes may be avoided. Alternatively, the temperature setpoint value may, however, also depend on other vehicle conditions.

If the detected temperature value deviates from the temperature setpoint value, a differential value is created, for example, which is used as an additional basis for the computation of a manipulated variable. The current supplied to converter 201 is used as the manipulated variable. In order to adjust the current supplied to converter 201, the converter has a current control device 211 which is connected to regulating device 215 via a control line 209. Current control device 211 has inputs IN1′ and INT and is connected upstream from converter circuit 213. Current control device 211 may be controlled via control line 209 in such a way that the current supplied to converter 201 may be adjusted to a certain value. Such a current control device 211 may include a controllable current limiting circuit such as a controllable series resistor.

FIG. 5 shows a control loop 301 which may be used to implement the present invention.

Control loop 301 represents a self-contained sequence of actions for influencing the temperature of converter 201 in a technical process. In this case, the recirculation of instantaneous, detected temperature value AV to a regulating device 303 via negative feedback FB is essential, while a continuous or discrete-time setpoint-actual comparison is carried out using a setpoint or a reference value RV.

The instantaneous temperature of converter 201 is detected at a point 309 and recirculated via feedback FB to point 307 where a system deviation is ascertained by comparing detected temperature value AV and temperature setpoint value RV. The ascertained system deviation is conveyed to regulator 303 which uses the system deviation to ascertain a manipulated or controlled variable CV. Manipulated variable CV is conveyed to controlled system 305 which includes current limiting circuit 211, for example. By using a control loop 301, there is the advantage of being able to keep the temperature of converter 201 at a certain temperature value. This temperature value may be selected in such a way that the thermal strain on the electronic components of converter 201 is less pronounced than what is known from the related art.

The determination of a system deviation may take place on the basis of a simple comparison between detected temperature value AV and setpoint temperature value RV, but it may also be based on more complex arithmetic operations.

In particular, a regulation may take place in such a way that in the presence of a system deviation, which exceeds a certain threshold, controlled variable CV is selected in such a way that a current supply to converter 201 is interrupted. This results in the temperature of converter 201 dropping subsequently. As soon as the temperature of converter 201 has dropped again below a certain value, the ascertained system deviation is again below the threshold and the current supply may be resumed.

In the case of an alternative regulation, in the presence of a system deviation, which exceeds a certain threshold, controlled variable CV is selected in such a way that a current supply to converter 201 is reduced. This also results in the temperature of converter 201 dropping subsequently. As soon as the temperature of converter 201 has dropped again below a certain value, the ascertained system deviation is again below the threshold and the current supply to converter 201 may be increased.

The present invention is, however, not limited to the above-described regulations, but it is also possible to use all fed back regulations and control loops which are suitable and allow the temperature of converter 301 to be adjusted to a previously selected temperature setpoint value RV and essentially kept at this value, so that a setpoint temperature is used as the reference variable.

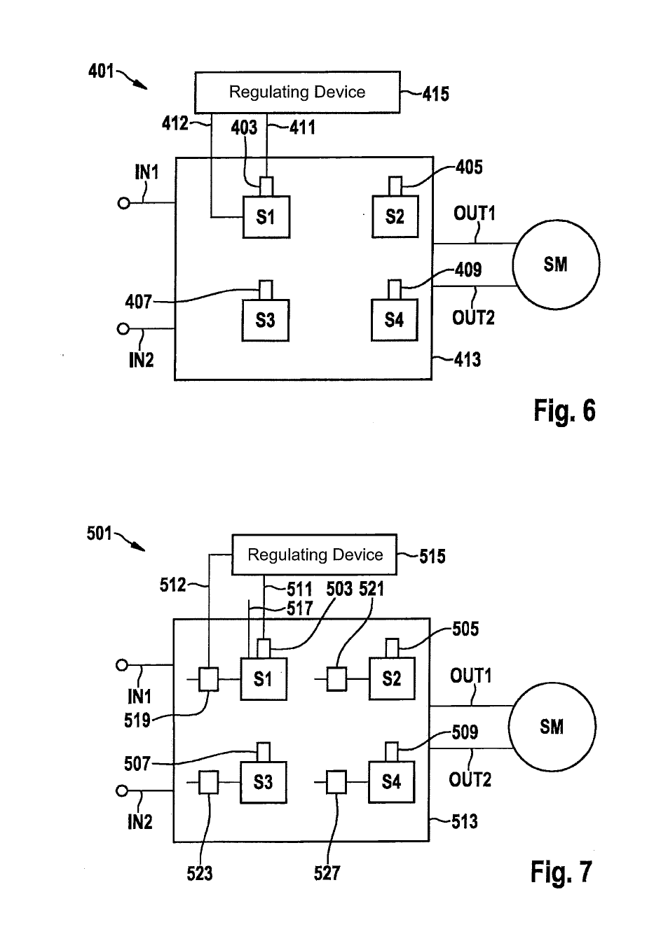

FIG. 6 shows a second specific embodiment of a converter 401 according to the present invention. In this specific embodiment, converter 401 also includes a-converter circuit 413 having the two inputs IN1 and IN2, the two outputs OUT1 and OUT2, and the four switching elements S1, S2, S3 and S4 which are connected to starter motor SM.

In this specific embodiment, however, on each switching element S1, S2, S3 and S4, there is an individual temperature detection device 403, 405, 407 and 409 which may be formed by the devices already mentioned above.

Each temperature detection device 403, 405, 407 and 409 may in this case detect the temperature of the particular switching element S1, S2, S3 and S4 independently of one another. In particular, the temperature may be detected on a switching semiconductor component, a rectifying component, or any other active or passive component, e.g., a resistor. The number of possible temperature detection devices is not limited to one per switching element S1, S2, S3 and S4, but it is possible for other temperature detection devices to also be provided, e.g., two per each of switching elements S1, S2, S3 and S4, one of the temperature detection devices detecting the temperature of the switching semiconductor component and the other detecting the temperature of the rectifying semiconductor component. A larger number of measuring points is advantageous in that the current flowing to converter 401 may be controlled in such a way that a particularly uniform temperature distribution is ensured during operation and a thermal load on the individual components is monitored particularly precisely. It is, however, also possible to provide corresponding temperature detection devices only for some of the switching elements.

In order to simplify the illustration, the control loop for controlling the temperature using a setpoint temperature as the reference variable is shown only for the first switching element 51, although the remaining switching elements S2, S3 and S4 are equipped with corresponding control loops in this specific embodiment. Overall, the temperature in the specific embodiment shown in FIG. 6 is controlled via four independent control loops, each of which may use its own setpoint temperature as the reference variable.

Temperature detection device 403 transmits via signal line 411 the instantaneous temperature value of the first switching element S1 to regulating device 415, which in this case is not only used to control the temperature of switching elements S1, S2, S3 and S4 using a setpoint temperature as the reference variable, but it is used at the same time to control switching elements S1, S2, S3 and S4. For this purpose, switching element S1 is connected to control and regulating device 415 via a control line 412. If control and regulating device 415 detects that there is a deviation of the measured temperature from the setpoint value, switching element S1 is controlled in such a way that the current is reduced which is supplied to starter motor SM via switching element S1. The current supplied to converter 401 is indirectly also controlled thereby. This type of control may be achieved, for example, by extending the off intervals in the case of a pulse-width control system. However, other control methods for switching elements S1, S2, S3 and S4 are also conceivable for this purpose, which are used overall to control the current supplied to converter 413.

In particular, these types of temperature-based controls may be carried out independently of one another for each switching element S1, S2, S3 and S4 using a setpoint temperature as the reference variable, so that a particularly uniform distribution of the temperature may be achieved. Furthermore, it is here also conceivable to use an individual setpoint temperature as the reference variable for each of the switching elements or for each of the temperature sensors used.

FIG. 7 shows a third specific embodiment of a converter 501 according to the present invention. In this specific embodiment, converter 501 also includes a converter circuit 513 having the two inputs IN1 and IN2, the two outputs OUT1 and OUT2, and the four switching elements S1, S2, S3 and S4 which are connected to starter motor SM.

In this specific embodiment, on each switching element S1, S2, S3 and S4, there is an individual temperature detection device 503, 505, 507, and 509 which may be formed by the devices already mentioned above. Each temperature detection device 503, 505, 507 and 509 may in this case detect the temperature of the particular switching element S1, S2, S3 and S4 independently of one another. In addition, each switching element S1, S2, S3 and S4 includes its own controllable current control device 519, 521, 523 and 527. Each of these current control devices 519, 521, 523 and 527 is capable of independently controlling the current supplied to switching elements S1, S2, S3 and S4.

In order to simplify the illustration, the control loop for controlling the temperature using a setpoint temperature as the reference variable is shown only for the first switching element S1, although the remaining switching elements S2, S3 and S4 are equipped with corresponding control loops in this specific embodiment. Overall, the temperature of switching elements S1, S2, S3 and S4 is controlled via four independent control loops in the specific embodiment shown in FIG. 7. The state of each switching element S1, S2, S3 and S4 is controlled via one control line 517 which is also shown only for switching element S1 for the sake of simplicity.

Temperature detection device 503 of switching element S1 is connected to regulating device 515 via a signal line 511. In addition, regulating device 515 is connected to current control device 519 via a control line 512. If control and regulating device 515 detects that there is a deviation of the measured temperature from the setpoint value, regulating device 515 controls current control device 519 in such a way that the temperature of switching element S1 is reduced to the setpoint value. This also controls the current flowing overall to converter 501. Regulating device 515 may not only be used for controlling current control device 519, but also for controlling switching element S1 via control line 517.

However, it is basically also possible to equip only some of switching elements S1, S2, S3, and S4 with controllable current control devices. For example, only the two switching elements S1 and S3 or the two switching elements S1 and S2 may be provided with current control devices.

Additionally, it is also possible in this case to use current-controlling switching of switching elements S1, S2, S3, and S4 in conjunction with additionally controlling current control devices 519, 521, 523, and 527 in order to control a supplied current in such a way that the desired setpoint temperatures are maintained. In this way, the advantage is achieved that a setpoint temperature is adjusted particularly effectively and efficiently.

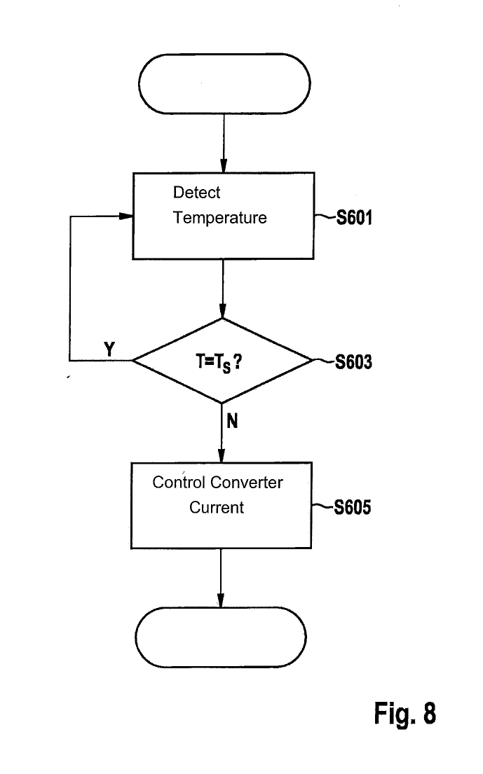

FIG. 8 shows a flow chart for controlling the temperature of the converter. In step S601, present temperature T of the converter is initially detected at a suitable point, e.g., at a housing, at a printed circuit board or at an electronic component. The detection of temperature T takes place with the aid of a suitable temperature detection device which is also capable of determining the temperature indirectly via a current or a voltage measurement, for example.

In step S603, detected temperature T is compared to a fixed setpoint temperature Ts. If detected temperature value T and setpoint temperature Ts match, the method branches in branch S603-Y again to step S601, and the detection of temperature T is repeated immediately or after a certain time period.

If it is determined in step S603 that there is a deviation between detected temperature value T and setpoint temperature value Ts, the method branches in branch S603-N to step S605.

Then, in step S605, the current supplied to the converter is controlled in such a way that detected temperature T subsequently approaches setpoint temperature Ts. This may, for example, be achieved by temporarily interrupting or reducing the supplied current. For this purpose, a controlled variable is computed which is transmitted to an appropriate current control device within the converter and toward which the supplied current is controlled.

After step S605, the illustrated method starts from the beginning, thus resulting in a contained control loop in which the current supplied to the converter is controlled by using a setpoint temperature Ts as the reference variable.

This results in the advantage that a uniform spatiotemporal temperature of the converter is achievable and the thermal load on the converter is reduced.

All features and method steps described in conjunction with the different specific embodiments of the present invention may be combined with each other in any way in order to achieve their advantageous effects.

1.-10. (canceled)

11. A method for operating a converter for a starter motor of a vehicle, comprising:
detecting a temperature of the converter; and
controlling a current supplied to the converter as a function of the detected temperature using a setpoint temperature as a reference variable.

12. The method as recited in claim 11, wherein the setpoint temperature is established as a function of a vehicle condition.

13. The method as recited in claim 11, further comprising reducing the supplied current if the setpoint temperature is exceeded.

14. The method as recited in claim 11, further comprising interrupting the supplied current if the setpoint temperature is exceeded.

15. The method as recited in claim 11, further comprising detecting a temperature of a semiconductor component of the converter.

16. The method as recited in claim 15, wherein the semiconductor component includes one of a switchable component and a rectifying component.

17. The method as recited in claim 11, further comprising detecting a temperature of multiple semiconductor components of the converter.

18. The method as recited in claim 17, wherein a current supplied to a particular one of the semiconductor components is controlled as a function of a detected temperature of the particular semiconductor component.

19. The method as recited in claim 11, wherein the supplied current is controlled via a pulse-width modulation.

20. A converter for a starter motor of a vehicle, comprising:
a temperature detection device for detecting a temperature of the converter; and
a regulating device for controlling a current supplied to the converter as a function of the detected temperature using a setpoint temperature as a reference variable.
